(19) United States
(12) Patent Application Publication
(10) Pub. No.: US 2010/0070660 A1
(43) Pub. Date: Mar. 18, 2010

(54) Detecting access of video teleconferencing endpoint hardware device serial port

(76) Inventor: David Karl Serisky, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/210,675

(22) Filed: Sep. 15, 2008

(51) Int. Cl. G06F 3/00

(52) U.S. Cl. 710/16

(57) ABSTRACT

That a serial port of a video teleconferencing endpoint hard device has been accessed is detected. In response to detecting that the serial port of the device has been accessed, one or more actions are performed. These actions include alerting a user that the serial port has been accessed.

Video teleconferencing employs a number of endpoints situated at different locations. At each endpoint, there is usually a video camera, a microphone, a video display, and a speaker. Video and audio at each endpoint is transmitted to the other endpoints, at which the video is displayed at the video displays, and at which the audio is output over the speakers. Generally, the hardware at the endpoints communicate with one another over a network.

As such, the hardware at the endpoints is typically configurable via networking protocols like the hypertext transport protocol (HTTP), Telnet, and the file transfer protocol (FTP). The hardware at the endpoints may also be remotely configurable over these networking protocols. Because remote configuration is susceptible to hacking attempts, typically a password has to be correctly entered before remote configuration over a network protocol is permitted.

However, the password may be lost. Therefore, as a last resort technique by which configuration of endpoint hardware is permitted, the endpoint hardware usually includes a serial port over which local configuration of the endpoint hardware can be achieved. Because configuration over the serial port is considered a last resort technique, no password typically has to be entered to configure endpoint hardware over the serial port.

Security for configuration over the serial port of endpoint hardware is generally provided in two ways. First, local (e.g., physical) access is needed to configure endpoint hardware using the serial port, which precludes remote hacking attempts. Second, the endpoint hardware may be physically secured so that physical access of the hardware is difficult to achieve. However, if a hacker does obtain local and physical access to endpoint hardware, there may be no way to know that security has been compromised.

### BRIEF DESCRIPTION OF THE DRAWINGS

FIG. 1 is a diagram of a representative video teleconferencing system, according to an embodiment of the present disclosure.

FIG. 2 is a block diagram of a video teleconferencing endpoint hardware device, according to an embodiment of the present disclosure.

FIG. 3 is a flowchart of a method by which serial port access of the endpoint hardware device of FIG. 2 is detected and responded to, according to an embodiment of the present disclosure.

### DETAILED DESCRIPTION OF THE DRAWINGS

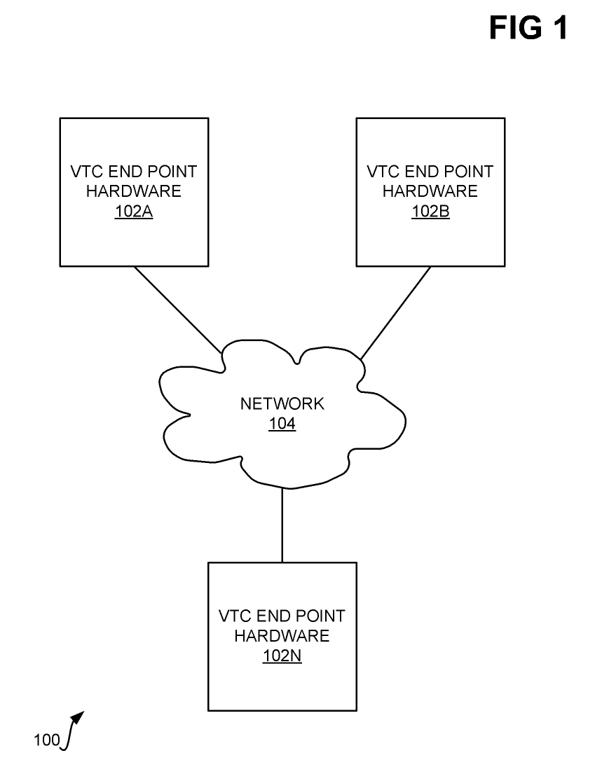

FIG. 1 shows a representative video teleconferencing system 100, according to an embodiment of the present disclosure. The video teleconferencing system 100 includes video teleconferencing endpoint hardware 102A, 102B, . . . , 102N, collectively referred to as the video teleconferencing endpoint hardware 102. There are at least two such hardware 102. The video teleconferencing endpoint hardware 102 communicate with one another over a network 104.

Each of the video teleconferencing endpoint hardware 102 is typically situated at a different location, such as different conference rooms, different offices, different cities, and/or different countries, for instance. Participants employing the hardware 102 at one of the locations can thus conduct a video teleconference with other participants of the hardware 102 at the other locations. Locally detected video and/or audio is transmitted from a given endpoint hardware 102 over the network 104 to the endpoint hardware 102 at the other locations, at which the video is displayed and/or at which the audio is output.

The network 104 may be any of a number of different types of networks. For instance, the network 104 may include a wired network and/or a wireless network. The network 104 may be or include the Internet, intranets, and extranets, as well as landline telephony networks, mobile telephony networks, an integrated services digital network (ISDN), and Ethernet networks, among other types of networks.

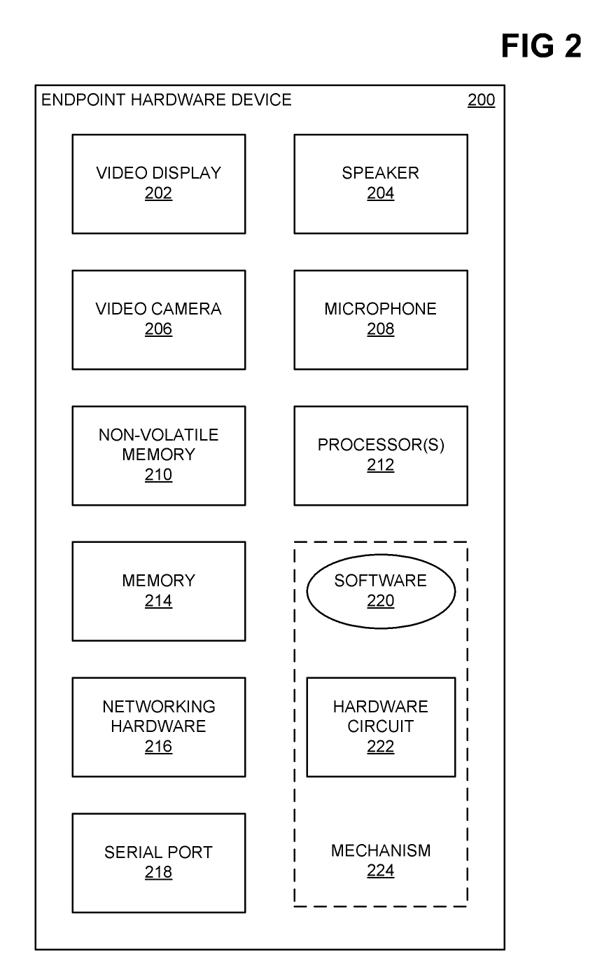

FIG. 2 shows a block diagram of video teleconferencing endpoint hardware device 200 that can implement any of the endpoint hardware 102, according to an embodiment of the disclosure. The endpoint hardware device 200 can include a video display 202, a speaker 204, a video camera 206, a microphone 208, non-volatile memory 210, one or more processors 212, volatile memory 214, networking hardware 216, a serial port 218, software 220, and/or a hardware circuit 222. The endpoint hardware device 200 may also include other components, in addition to and/or in lieu of those depicted in FIG. 2. At least the video display 202, the speaker 202, the video camera 206, and the microphone 208 are considered video teleconferencing hardware components, in that they perform functionality, as described below, that permits the hardware device 200 to act as a video teleconferencing endpoint hardware device. Furthermore, the serial port 218 is at least communicatively connected to these video teleconferencing hardware components.

The various components of the hardware device 200 may be disposed within the same physical enclosure. Alternatively, the components may be separated over a number of different physical enclosures and connected to one another via appropriate cabling. Whereas embodiments of the present disclosure are substantially described in relation to a given device being a video teleconferencing endpoint hardware device, in other embodiments the device may not be a video teleconferencing endpoint hardware device at all, and may instead be another type of device, such as a general purpose computing device, among other types of devices.

The video display 202 permits remotely detected video to be displayed at the location of the endpoint hardware device 200. Likewise, the speaker 204 permits remotely detected audio to be output at the location of the endpoint hardware device 200. The video camera 206 detects video at the location of the endpoint hardware device 200, whereas the microphone 208 detects audio at the location of the endpoint hardware device 200.

The non-volatile memory 210 is memory that retains its contents even if power is removed from the device 200 and thus from the memory 210. The memory 210 may be semiconductor memory. The processors 212 execute software, such as the software 220 as well as other software of the endpoint hardware device 200, and may be supplemented by other more special-purpose processing hardware, such as application-specific integrated circuits (ASIC's), and digital signal processors (DSP's). The memory 214 is volatile memory that does not retain its contents when power is removed from the device 200 and thus from the memory 214. The memory 214 may also be semiconductor memory.

The networking hardware 216 permits the endpoint hardware device 200 to communicate over the network 104 with the other video teleconferencing endpoint hardware 102. The networking hardware 216 thus provides for networking connectivity, such as wired networking connectivity and/or wireless networking connectivity. Configuration of the endpoint hardware device 200 may be remotely achieved by communicating with the endpoint hardware device 200 over the network 104 via the networking hardware 216, upon the remote entry of the correct password, for instance.

Configuration of the endpoint hardware device 200 can include specifying the network settings of the device 200, such as its network address (e.g., its Internet Protocol (IP) address), as well as specifying other parameters of the device 200. Other such configuration parameters include passwords, whether a control panel is unlocked or enabled, whether auto-answer is enabled, whether remote camera control is permitted, and so on. The control panel, for instance, permits a user to modify the configuration via remote control. Another configuration parameter is a factory reset command, that if issued may completely clear memory and render the device 200 essentially unusable.

The serial port 218 may be a standard RS-232 serial port having a typical DB9 connector, or may be another type of serial port, such as an RS-485 serial port. The serial port 218 permits local configuration of the endpoint hardware device 200 without requiring the entry of a password. As such, because anyone having physical and local access to the serial port 218 is able to reconfigure the hardware device 200, the enclosure of the device 200 that includes the serial port 218 may be physically secured. For instance, this enclosure may be stored in a locked cabinet or room.

The software 220 and/or the hardware circuit 222 make up what is referred to herein as a mechanism 224. The mechanism 224 detects access of the serial port 218 and performs one or more actions in response. In one embodiment, just the hardware circuit 222 is present, such that the software 220 is not. In another embodiment, both the hardware circuit 222 and the software 220 are present. In still another embodiment, just the software 220 is present, and the hardware circuit 222 is not. Thus, depending on whether the mechanism 224 includes only the software 220, only the hardware circuit 222, or both the software 220 and the hardware circuit 222, the mechanism 224 detects access of the serial port 218 using only hardware, using only software, or using both hardware and software.

The inclusion of the mechanism 224 within the endpoint hardware device 200 thus permits the detection of configuration of the hardware device 200 via the serial port 218, where such configuration would otherwise go undetected. Because the serial port 218 is an “open” port that is not secured by password or any other manner except by potentially being physically secured in a locked cabinet or room, the inclusion of the mechanism 224 is thus advantageous. Local intrusion attempts to access and modify the hardware device 200 via the serial port 218 can be advantageously detected and investigated pursuant to embodiments of the present disclosure.

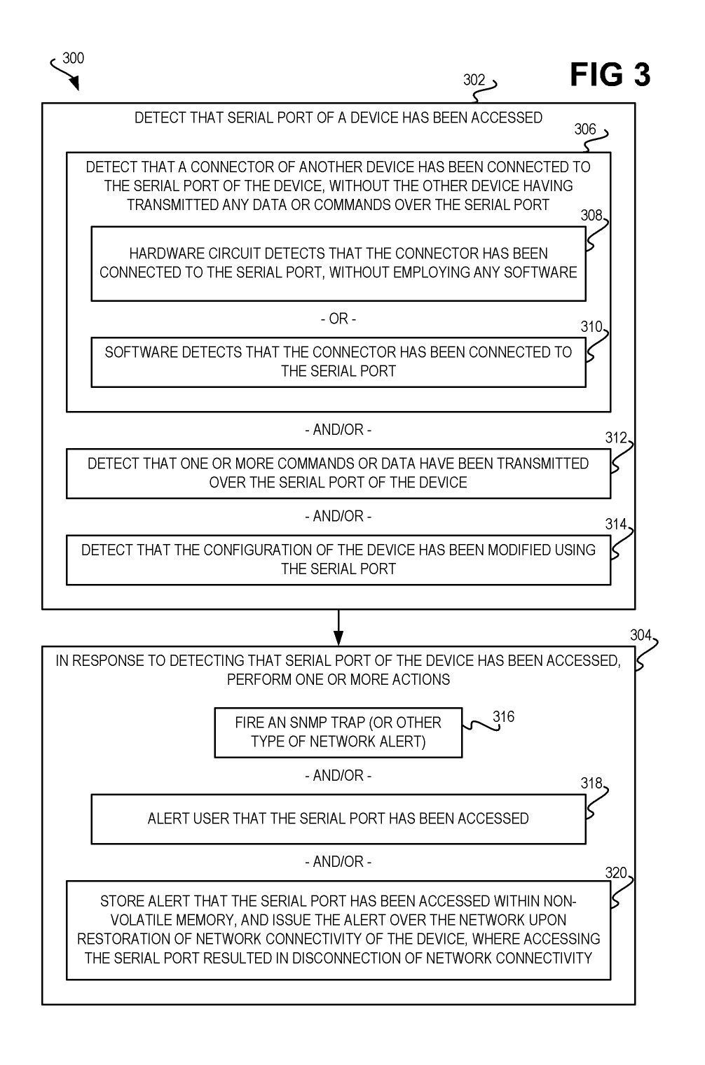

FIG. 3 shows a method 300 detailing how the mechanism 224 can detect and respond to access of the serial port 218 of the endpoint hardware device 200, according to an embodiment of the present disclosure. Thus, the various parts of the method 300 can be performed at least in part by the mechanism 224 in one embodiment. The method 300 generally includes detecting that the serial port 218 of the device 200 has been accessed (302), and in response to such detection, performing one or more actions (304). Each of these parts is now described in more detail.

Detecting that the serial port 218 has been accessed in part 302 may be achieved in a lowest level manner (306), a mid-level manner (312), or a highest level manner (314). In the lowest level manner, the connection of a connector of another device to the serial port 218 of the device 200 is detected (306), without the other device transmitting any data or commands over the serial port 218. That is, detection that the serial port 218 has been accessed is accomplished simply by detecting the actual physical connection of a connector of another device to the serial port 218.

For instance, the act of physically connecting a connector of another device to the serial port 218 of the device 200 may cause two or more pins of the serial port 218 to be electrically connected or grounded. As such, the act of physically connecting a connector of another device to the serial port 218 may be detected by the hardware circuit 222 that detects this electrical connection or grounding (308), without employing any software whatsoever. Alternatively, the software 220 may be used in lieu of or in addition to hardware, such as the hardware circuit 222, to detect the act of physically connecting a connector of another device to the serial port 218 (310).

In the mid-level manner, the transmission of one or more commands or data over the serial port 218 is detected (312) to detect that the serial port 218 of the device 200 has been accessed. The nature of the commands or the data that is transmitted over the serial port 218 can be irrelevant in the detection of part 312. The transmission of any commands or data transmitted over the serial port 218 is sufficient in this embodiment to detect that the serial port 218 has been accessed. Such detection may be achieved by the software 220 and/or by the hardware circuit 222.

In the highest level manner, modification of the configuration of the device 200 using the serial port 218 is detected (314) to detect that the serial port 218 of the device 200 has been accessed. Thus, it is not that commands or data per se having been transmitted over the serial port 218 that triggers the detection that the serial port 218 has been accessed, but the end result of those commands or data—the modification of the configuration of the device 200. Where the modification of the configuration of the device 200 is achieved using the serial port 218, such modification triggers detection that the serial port 218 has been accessed.

The lowest level manner of detection of part 306 is thus the lowest level of detection in that it does not matter that any electrical signals (representing data or commands) have been transmitted over the serial port 218; the act of physically connecting a connector of another device to the serial port 218 is sufficient to detect access of the serial port 218. By comparison, the mid-level manner of detection of part 312 is one level higher than the detection of part 306; in that just the act of physically connecting a connector to the serial port 218 does not trigger detection of access of the serial port 218. Rather, the transmission of electrical signals representing data or commands over the serial port 218 is detected, which is what triggers detection of access of the serial port 218.

Furthermore, the highest level of detection of part 314 is one level higher than the detection of part 312. This is because the simple transmission of data or commands over the serial port 218 does not trigger detection of access of the serial port 218 in part 314 as it does in part 312. Rather, the end result of transmission of such data or commands—the modification of the configuration of the device 200—is what triggers detection of access of the serial port in part 314.

Implementation of the hardware circuit 222 and the software 220 can be performed in a number of different ways. For instance, particularly as to the hardware circuit 222, a circuit can be constructed to detect that an electrical connection between two pins of the serial port 218 has resulted. For example, such an electrical connection may result in the resistance between the two pins decreasing from a substantially very high level to a substantially very low level. This decrease in resistance can be detected by the circuit 222. As another example, a circuit can be constructed to detect that a pin of the serial port 218 has been grounded, by measuring the voltage of the pin to ground, such that grounding of the pin results in this voltage being substantially zero.

The actions that are performed in part 304 in response to detecting that the serial port 218 of the device 200 has been accessed can include any of a number of different types of actions. Three different types of actions are described herein. First, a simple network management protocol (SNMP) trap or another type of network alert can be fired (316), or issued. An SNMP trap is generally employed to asynchronously report an event about a managed subsystem, which in this case is the detection that the serial port 218 of the device 200 has been accessed. An SNMP trap employs the SNMP, and thus is transmitted over the network 104 using the networking hardware 216 of the device 200. An example of another type of network alert is an alert issued by OpenView® networking software, available from the Hewlett-Packard Company of Palo Alto, Calif.

Second, a user can be alerted that the serial port 218 has been accessed (318). The alerting of a user can occur in a number of different forms. The SNMP trap or network alert of part 316 may be considered a user alert, for instance. An email may be sent to a user, via the networking hardware 216. A user alert may be visually displayed on the video display 202, or audibly output via the speaker 204. Other manners by which a user alert can be issued can also be employed.

Third, an alert that the serial port 218 of the device 200 has been accessed may be stored within the non-volatile memory 210 (214). For instance, the unauthorized access of the serial port 218 may change the configuration of the device 200 such that the device 200 is no longer able to communicate over the network 104 via the networking hardware 216. As such, the alerts of parts 316 and 318 if attempted to be transmitted may not be able to be transmitted due to this configuration change, since the network connectivity of the device 200 has been disconnected. Therefore, such an alert may also be stored in the non-volatile memory 210 of the device 200.

At some point, a user is likely to recognize that the endpoint hardware device 200 is no longer communicatively connected to the network 104, but may guess that the reason why is that the device 200 has encountered a bug in its operating software, or for another reason other than unauthorized access of the device 200. Therefore, the user may revert the configuration of the device 200 and/or reboot the device 200 so that it is again able to communicate over the network 104. At that time, the alert stored in the non-volatile memory 210 is issued over the network 104, once network connectivity of the device 200 has been restored. As such, the user ultimately does learn that the serial port 218 has been accessed.

As another example, a malicious user may disconnect the device 200 from the network 104, modify the configuration, and reconnect the device 200 back to the network 104. Therefore, the alert is stored in the non-volatile memory 210, just in case the user has disconnected the device 200 from the network 104, or if modification of the configuration resulted in the loss of network connectivity. Thus, when the device 200 is reconfigured so that it is again able to communicate over the network 104—or when the device 200 is simply reconnected to the network 104, if the configuration modification did not result in the loss of network connectivity—the alert stored in the non-volatile memory 210 is issued over the network 104.

Embodiments of the present disclosure thus permit the access of the serial port of a device to be detected, and for one or more actions to be responsively performed. The nature of the device in relation to which embodiments of the present disclosure can be practiced has been described substantially in relation to a video teleconferencing hardware device, although other types of devices can alternatively use the techniques that have been described herein. Especially where the serial port of a device is considered a last resort technique by which configuration of the device can be modified—such that serial port access is not secured by a password—embodiments of the present disclosure advantageously permit users to be notified when serial port access has occurred.

We claim:

1. A method comprising:
detecting that a serial port of a video teleconferencing endpoint hardware device has been accessed; and,
in response to detecting that the serial port of the video teleconferencing endpoint hardware device has been accessed, performing one or more actions,
wherein the actions comprise:
alerting a user that the serial port of the video teleconferencing endpoint hardware device has been accessed.

2. The method of claim 1, wherein detecting that the serial port of the video teleconferencing endpoint hardware device has been accessed comprises detecting that a connector of another device has been connected to the serial port of the video teleconferencing endpoint hardware device, without the other device having transmitted any data or commands over the serial port of the video teleconferencing endpoint hardware device.

3. The method of claim 2, wherein detecting that the connector of the other device has been connected to the serial port of the device comprises a hardware circuit detecting that the connector of the other device has been connected to the serial port of the video teleconferencing endpoint hardware device, without employing any software to detect that the connector of the other device has been connected to the serial port of the video teleconferencing endpoint hardware device.

4. The method of claim 2, wherein detecting that the connector of the other device has been connected to the serial port of the video teleconferencing endpoint hardware device comprises software detecting that the connector of the other device has been connected to the serial port of the video teleconferencing endpoint hardware device.

5. The method of claim 1, wherein detecting that the serial port of the video teleconferencing endpoint hardware device has been accessed comprises detecting that one or more commands or data have been transmitted over the serial port of the video teleconferencing endpoint hardware device.

6. The method of claim 1, wherein detecting that the serial port of the video teleconferencing endpoint hardware device has been accessed comprises detecting that a configuration of the video teleconferencing endpoint hardware device has been modified using the serial port of the video teleconferencing endpoint hardware device.

7. The method of claim 1, wherein performing the one or more actions comprises firing a simple network management protocol (SNMP) trap.

8. The method of claim 1, wherein performing the one or more actions comprises storing an alert that the serial port of the video teleconferencing endpoint hardware device has been accessed, the alert stored in non-volatile memory of the video teleconferencing endpoint hardware device.

9. The method of claim 8, wherein performing the one or more actions further comprises issuing the alert over a network upon restoration of network connectivity of the video teleconferencing endpoint hardware device, where accessing of the serial port of the video teleconferencing endpoint hardware device resulted in disconnection of the network connectivity of the video teleconferencing endpoint hardware device.

10. A video teleconferencing endpoint hardware device comprising:
one or more video teleconferencing hardware components;
a serial port communicatively coupled to the video teleconferencing hardware components; and,
a mechanism to detect that the serial port has been accessed and to perform one or more actions in response to detecting that the serial port has been accessed,
wherein the actions comprise:
alerting a user that the serial port of the video teleconferencing endpoint hardware device has been accessed.

11. The video teleconferencing endpoint hardware device of claim 10, wherein the mechanism is one of: a hardware-only circuit, and a software mechanism.

12. The video teleconferencing endpoint hardware device of claim 10, wherein the mechanism is to detect that the serial port has been accessed by one of:
detecting that a connector of another device has been connected to the serial port, without the other device having transmitted any data or commands over the serial port;
detecting that one or more commands or data have been transmitted over the serial port; and,
detecting that a configuration of the video teleconferencing endpoint hardware device has been modified using the serial port.

13. The video teleconferencing endpoint hardware device of claim 10, wherein the one or more actions performed by the mechanism in response to detecting that the serial port has been accessed further comprise:
firing a simple network management protocol (SNMP) trap.

14. The video teleconferencing endpoint hardware device of claim 10, wherein the one or more actions performed by the mechanism in response to detecting that the serial port has been accessed further comprise:
storing an alert that the serial port has been accessed within non-volatile memory of the video teleconferencing endpoint hardware device, and issuing the alert over a network upon restoration of network connectivity of the video teleconferencing endpoint hardware device, where accessing of the serial port resulted in disconnection of the network connectivity of the video teleconferencing endpoint hardware device.
